(19) United States
(12) Patent Application Publication
(10) Pub. No.: US 2011/0063240 A1
(43) Pub. Date: Mar. 17, 2011

(54) TOUCH PANEL

(76) Inventor: Koji TANABE, Osaka (JP)

(21) Appl. No.: 12/883,722

(22) Filed: Sep. 16, 2010

(30) Foreign Application Priority Data
Sep. 17, 2009 (JP) 2009-215346
Dec. 17, 2009 (JP) 2009-286128
Jul. 28, 2010 (JP) 2010-168891

(51) Int. Cl. G06F 3/041

(52) U.S. Cl. 345/173

(57) ABSTRACT

A touch panel includes a plurality of belt-shaped upper electrodes extending from a plurality of upper conductive layers in the perpendicular direction thereto. The upper electrodes are formed of a copper foil, and thereby it is possible to form the upper electrodes which realize thinned line or narrowed line interval without spread or scratch, by using an etching process or the like. The overall miniaturization or increase in an operation region cannot only be implemented, but stable connection to electronic circuits of a device can be also performed, thereby obtaining the touch panel which can be reliably operated.

### BACKGROUND OF THE INVENTION

1. Field of the Invention

The present invention relates to a touch panel used to operate various kinds of electronic devices.

2. Description of the Related Art

In recent years, various kinds of electronic devices such as cellular phones, electronic cameras or the like have become increasingly multi-functional and diverse. Therefore, devices in which touch panels having a light transmissive characteristic are mounted on the front faces of display devices such as liquid crystal display devices or the like are increasing. In such a device, there are an increasing number of cases where a user views a display on the display device placed in the rear face of the touch panel and touches the touch panel with a finger or the like for operation, such that various functions of the device are switched. Thus, it has recently become necessary to perform reliable operations at a low cost.

Such a touch panel in the related art will be described with reference to FIG. 8. In order to easily recognize constituent elements in the figure, the dimensions thereof are partially enlarged.

FIG. 8 is an exploded perspective view of a touch panel in the related art. In FIG. 8, the touch panel includes upper substrate 1, upper conductive layers 2, upper electrodes 3, lower substrate 4, lower conductive layers 5, lower electrodes 6, cover substrate 7.

Upper substrate 1 has a film shape and a light transmissive characteristic. A plurality of substantially belt-shaped upper conductive layers 2 are arranged and formed on an upper surface of upper substrate 1 in the longitudinal direction. Upper conductive layers 2 are made of indium tin oxide or the like and have a light transmissive characteristic. Upper electrodes 3 are formed in plurality, one ends of which are connected to end portions of upper conductive layers 2 and the other ends thereof extend to the right end of the outer circumferential portion of upper substrate 1. Upper electrodes 3 are formed in the direction (transverse direction) perpendicular to upper conductive layers 2. Upper electrodes 3 are made of silver, carbon, or the like.

Lower substrate 4 has a film shape and a light transmissive characteristic. A plurality of substantially belt-shaped lower conductive layers 5 is arranged and formed on the upper surface of lower substrate 4 in the transverse direction perpendicular to upper conductive layers 2. Lower conductive layers 5 are made of indium tin oxide or the like and have a light transmissive characteristic. Lower electrodes 6 are formed in plurality, one ends of which are connected to the end portions of lower conductive layers 5 and the other ends thereof extend to the right end of the outer circumferential portion of lower substrate 4. Lower electrodes 6 are formed extending in the transverse direction parallel to lower conductive layers 5. Lower electrodes 6 are made of silver, carbon, or the like.

Cover substrate 7 has a film shape and a light transmissive characteristic. Upper substrate 1 overlaps the upper surface of lower substrate 4. In addition, cover substrate 7 overlaps the upper surface of upper substrate 1. They are respectively attached to each other by adhesives (not shown) or the like. The touch panel is configured in this way.

The touch panel configured in this way is disposed on a front face of a display device such as a liquid crystal display device or the like and mounted on an electronic device. At this time, a plurality of upper electrodes 3 or lower electrodes 6 of the touch panel is electrically connected to electronic circuits (not shown) of the electronic device via a flexible wire board, a connector (not shown) or the like.

In the above-described configuration, in a state where a plurality of upper electrodes 3 and lower electrodes 6 is sequentially applied with voltages from the electronic circuits, the upper surface of cover substrate 7 is touched by a finger or the like for operation according to the display on the display device placed in the rear face of the touch panel. Thereby, a capacitance between upper conductive layers 2 and lower conductive layers 5 in the operated place varies, the electronic circuits detect the operated place, and thus various functions of the electronic device are switched.

In other words, for example, if a finger or the like touches the upper surface of cover substrate 7 over a desired menu in a state where a plurality of menus or the like is displayed on the display device placed in the rear face of the touch panel, a portion of charges are conducted to the finger. Thereby, a capacitance between upper conductive layers 2 and lower conductive layers 5 of the touch panel in the operated place varies. The electronic circuits detect the variation of the capacitance and thereby selection of a desired menu or the like is performed.

In order to manufacture upper substrate 1 or lower substrate 4 of the touch panel, generally, upper substrate 1 or lower substrate 4 of which an entire upper surface is provided with a thin film made of indium tin oxide or the like is immersed in an etchant, and a plurality of upper conductive layers 2 or lower conductive layers 5 having a substantially belt shape are formed on the upper surface of upper substrate 1 or lower substrate 4.

Thereafter, a plurality of upper electrodes 3 or lower electrodes 6 made of silver, carbon, or the like is formed by a screen printing or the like.

In this way, there is completion of upper substrate 1 or lower substrate 4, each of which the upper surface is provided with a plurality of upper conductive layers 2 or lower conductive layers 5, and upper electrodes 3 or lower electrodes 6 having one ends connected to the end portions of the conductive layers and the other ends extending to the right end of the outer circumference thereof.

However, when a plurality of upper electrodes 3 or lower electrodes 6 is formed using the screen printing or the like, if the line width of upper electrode 3 or lower electrode 6 or the dimension between lines is to be reduced, spreading or scratching is easily generated. Particularly, the spreading or the scratching is especially easily generated in upper electrodes 3 which are formed thin and long in the front and rear portions of upper substrate 1 while extending in the transverse direction perpendicular to upper conductive layers 2. Thereby, there is a case where connection to the electronic circuits of the electronic device is unstable.

For this reason, the line width of upper electrode 3 or the dimension between lines cannot be formed too small and thus typically is formed in the dimension of about 0.1 mm or more. Therefore, the dimension of the profile of upper substrate 1 in the longitudinal direction increases, or an operation region which can be touched by a finger or the like decreases.

Since unnecessary parts in the metal thin film of relatively high-priced indium tin oxide or the like formed on the entire upper surface of upper substrate 1 or lower substrate 4 are removed using an etching process to form a plurality of upper conductive layers 2 or lower conductive layers 5, it is also difficult to realize a low price.

Japanese Patent Unexamined Publication No. 2009-93397 is an example of the related art.

However, in a touch panel in the related art, when the line width of each of a plurality of upper electrodes 3 formed thin and long in the front and rear end portions of upper substrate 1 or the dimension between lines is made small, the spreading or the scratching is easily generated, and thus it is difficult to thin the lines or to narrow the line interval. Thereby, there is a problem in that since the dimension of the profile of upper substrate 1 in the longitudinal direction increases, or the operation region which can be touched by a finger or the like decreases, it is difficult to realize overall miniaturization or an increase in the operation region.

### SUMMARY OF THE INVENTION

The present invention provides a touch panel which can be reliably operated at a low cost while implementing miniaturization or an increase in an operation region.

A touch panel according to an embodiment of the present invention includes an upper substrate, a lower substrate opposite to the upper substrate with a predetermined gap therebetween, a plurality of belt-shaped upper conductive layers formed on the upper substrate and arranged in a predetermined direction, a plurality of upper electrodes having one ends connected to end portion of the upper conductive layers and the other ends extending to an outer circumference of the upper substrate, a plurality of belt-shaped lower conductive layers formed on the lower substrate and arranged in a direction perpendicular to the upper conductive layers with a predetermined gap between the lower conductive layers and the upper conductive layers, and a plurality of lower electrodes having one ends connected to end portion of the lower conductive layers and the other ends extending to an outer circumference of the lower substrate. At least one of the upper electrodes and the lower electrodes is formed of a copper foil. By this configuration, it is possible to miniaturize the overall touch panel and increase an operation region. Also, connection to electronic circuits of an electronic device can be stably performed and thus it is possible to obtain a touch panel which can be reliably operated.

### BRIEF DESCRIPTION OF THE DRAWINGS

FIG. 1 is a sectional view of a touch panel according to a first embodiment of the present invention.

FIG. 2 is an exploded perspective view of the touch panel according to the first embodiment of the present invention.

FIG. 3 is a plan view of the touch panel according to the first embodiment of the present invention.

FIG. 4A is a plan view of the touch panel according to the first embodiment of the present invention.

FIG. 4B is a plan view of the touch panel according to the first embodiment of the present invention.

FIG. 4C is a plan view of the touch panel according to the first embodiment of the present invention.

FIG. 5 is a sectional view of a touch panel according to a second embodiment of the present invention.

FIG. 6 is an exploded perspective view of the touch panel according to the second embodiment of the present invention.

FIG. 7A is a partially sectional view of the touch panel according to the second embodiment of the present invention.

FIG. 7B is a partially sectional view of the touch panel according to the second embodiment of the present invention.

FIG. 7C is a partially sectional view of the touch panel according to the second embodiment of the present invention.

FIG. 7D is a partially sectional view of the touch panel according to the second embodiment of the present invention.

FIG. 7E is a partially sectional view of the touch panel according to the second embodiment of the present invention.

FIG. 8 is an exploded perspective view of a touch panel in the related art.

### DESCRIPTION OF PREFERRED EMBODIMENT

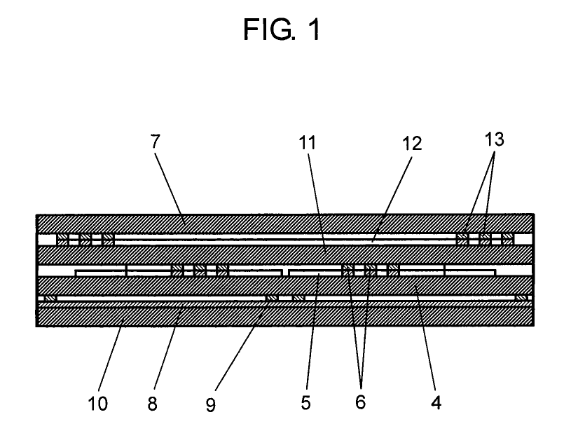

Hereinafter, embodiments of the present invention will be described with reference to FIGS. 1 to 7E. Constituent elements are partially enlarged in their dimensions in order to be easily recognized. Constituent elements the same as those described in the Description of the Related Art are given the same reference numerals and the description thereof will be simplified. The definition for directions such as front and rear, left and right, upper and lower, and the like is for explaining positional relationships between the respective constituent elements in this embodiment, and the elements are not necessarily disposed in those directions.

### First Embodiment

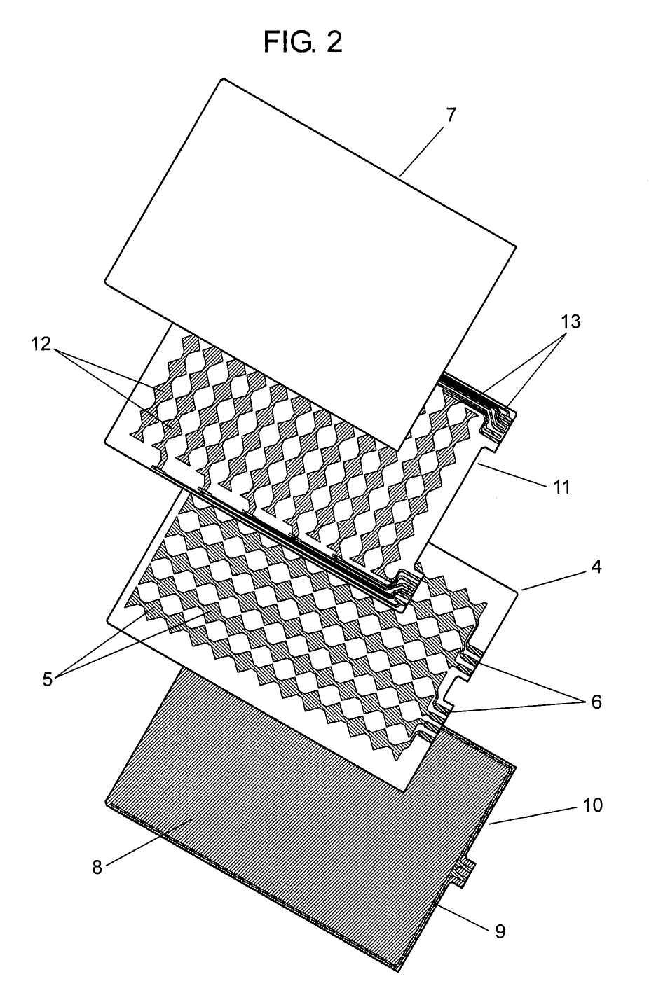

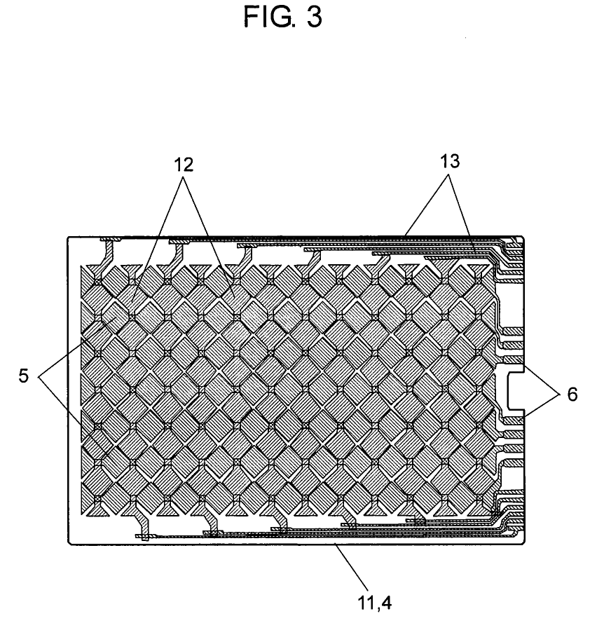

FIG. 1 is a sectional view of a touch panel according to a first embodiment of the present invention. FIG. 2 is an exploded perspective view of the touch panel according to the first embodiment of the present invention. FIG. 3 is a plan view of the touch panel according to the first embodiment of the present invention. In FIGS. 1 to 3, the touch panel in this embodiment includes upper substrate 11, upper conductive layers 12, upper electrodes 13, lower substrate 4, lower conductive layers 5, lower electrodes 6, cover substrate 7, base conductive layer 8, base electrode 9, and base substrate 10.

Upper substrate 11 has a film shape and a light transmissive characteristic. Upper substrate 11 is made of polyethylene terephthalate, polyether sulfone, polycarbonate, or the like. A plurality of substantially belt-shaped upper conductive layers 12 is arranged and formed on an upper surface of upper substrate 11 in the longitudinal direction by a sputtering method or the like. Upper conductive layers 12 are made of indium tin oxide, tin oxide, or the like and have a light transmissive characteristic. Also, upper electrodes 13 are formed on the upper surface of upper substrate 11 in the direction (transverse direction) perpendicular to upper conductive layers 12. Upper electrodes 13 have one ends connected to end portions of upper conductive layers 12 and the other ends extending to the right end of the outer circumference of upper substrate 11. Upper electrodes 13 are formed at end portions in the side to which upper conductive layers 12 extend on upper substrate 11 (that is, the front end portion and the rear end portion of upper substrate 11). Upper electrodes 13 are formed by laminating a copper foil on indium tin oxide, tin oxide, or the like through a deposition or the like.

Lower substrate 4 has a film shape and a light transmissive characteristic. A plurality of substantially belt-shaped lower conductive layers 5 is arranged and formed on an upper surface of lower substrate 4 in the direction (transverse direction) perpendicular to upper conductive layers 12. Lower conductive layers 5 are made of indium tin oxide, tin oxide, or the like and have a light transmissive characteristic. Also, a plurality of lower electrodes 6 is formed on the upper surface of lower substrate 4 in the transverse direction parallel to the lower conductive layers. Lower electrodes 6 have one ends connected to end portions of lower conductive layers 5 and the other ends extending to the right end of the outer circumference of lower substrate 4. Lower electrodes 6 are formed at end portions in the side to which lower conductive layers 5 extend on the lower substrate 4 (the right end portion in this embodiment). Lower electrodes 6 are made of silver, carbon, or the like.

A plurality of upper conductive layers 12 and lower conductive layers 5 are formed by connecting a plurality of rectangular portions to each other in the belt shape. A plurality of substantially rectangular gap portions is provided between upper conductive layers 12 or lower conductive layers 5. As shown in FIG. 3, in the state where upper substrate 11 overlaps lower substrate 4, the rectangular portions of upper conductive layers 12 overlap the gap portions of lower electrodes 6, and the rectangular portions of lower conductive layers 5 overlap the gap portions of upper electrodes 13.

Base substrate 10 has a film shape and a light transmissive characteristic. Base substrate 10 is made of polyethylene terephthalate or the like. Base conductive layer 8 having a light transmissive characteristic is formed on the entire upper surface of base substrate 10. Base conductive layer 8 is made of indium tin oxide, tin oxide, or the like. Base electrode 9, which extends to the right end of the outer circumference from the front end portion and the rear end portion of base conductive layer 8, is formed on the upper surface of base substrate 10. Base electrode 9 is formed in substantially U shape and is made of silver, carbon, or the like.

Cover substrate 7 has a film shape and a light transmissive characteristic. Lower substrate 4, upper substrate 11, and cover substrate 7 overlap the upper surface of base substrate 10, and they are respectively attached to each other by adhesives (not shown) such as acryl, rubber, or the like, which thus configures the touch panel.

In other words, in the touch panel in this embodiment, a plurality of upper conductive layers 12 arranged and formed in the longitudinal direction and lower conductive layers 5 arranged and formed in the transverse direction perpendicular to upper conductive layers 12 are disposed opposite to each other with a predetermined gap by interposing upper substrate 11 therebetween.

The touch panel configured in this way is disposed on a front face of a display device such as a liquid crystal display device and mounted on an electronic device. At this time, a plurality of upper electrodes 13, lower electrodes 6, and base electrode 9 are electrically connected to electronic circuits (not shown) of the electronic device via a flexible wire board or a connector (not shown).

In the above-described configuration, in the state where the electronic circuits sequentially supply voltages to a plurality of upper electrodes 13 and lower electrodes 6, a finger or the like touches the upper surface of cover substrate 7 for operation, according to the display on the display device placed in the rear face of the touch panel. Thereby, a capacitance between upper conductive layers 12 and lower conductive layers 5 in the operated place varies. The operated place is detected by the electronic circuits based on the variation of the capacitance, and various functions of the electronic device are switched.

In other words, for example, if a finger or the like touches the upper surface of cover substrate 7 over a desired menu in a state where a plurality of menus or the like is displayed on the display device placed in the rear face of the touch panel, a portion of electrical charge is conducted to the finger. Thereby, a capacitance between upper conductive layers 12 and lower conductive layers 5 of the touch panel in the operated place varies. The electronic circuits detect the variation of the capacitance and thereby selection of a desired menu or the like is performed.

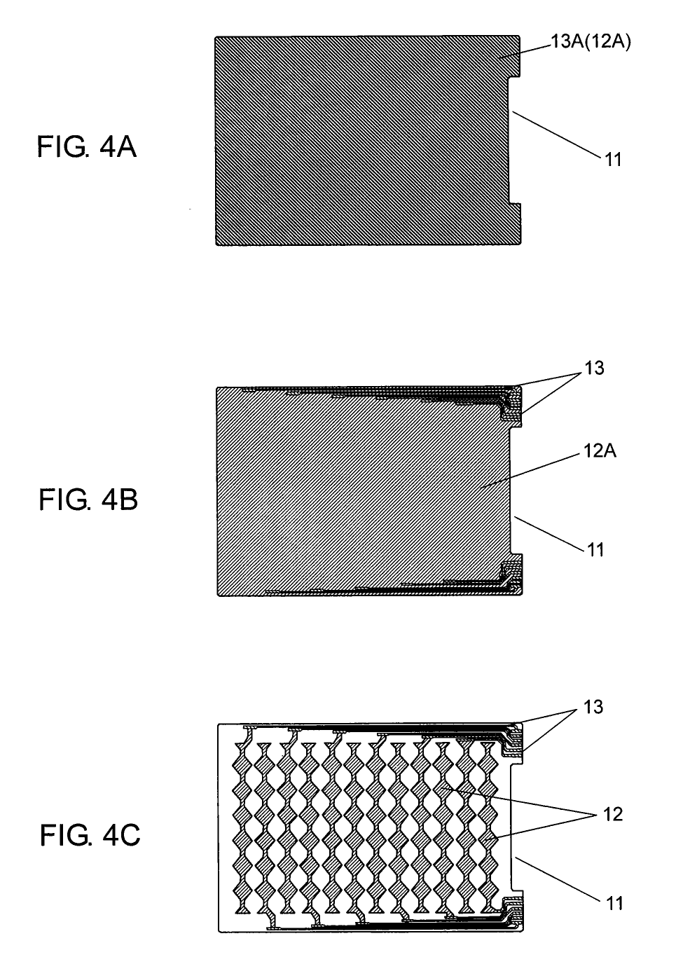

An example of manufacturing upper substrate 11 of the touch panel will be described with reference to FIGS. 4A to 4C. As shown in FIG. 4A, first, a thin film 12A made of indium tin oxide is formed on the entire upper surface of upper substrate 11. Next, copper foil 13A is laminated on the thin film 12A made of indium tin oxide.

The upper surface of copper foil 13A is exposed and developed by a photoresist method or the like so as to mask patterns of upper electrodes 13 with a coat made of an insulating resin such as a dry film or the like. Thereafter, upper substrate 11 is immersed in an etchant to melt and remove only copper foil 13A in unnecessary parts. Thereby, as shown in FIG. 4B, a plurality of upper electrodes 13 is formed on the upper surface of thin film 12A made of indium tin oxide.

A coat is formed on the upper surface of thin film 12A made of indium tin oxide by the photoresist method or the like in order to cover the patterns of upper electrodes 13. Next, upper substrate 11 is immersed in an etchant different from the above-described etchant to melt and remove thin film 12A in unnecessary parts. Thereby, upper substrate 11 is formed as shown in FIG. 4C. That is to say, on the upper surface of upper substrate 11, there are formed a plurality of substantially belt-shaped upper conductive layers 12, and a plurality of upper electrodes 13 having one ends connected to end portions of upper conductive layers 12 and the other ends extending to the right end of the outer circumference of upper substrate 11. Copper foil 13A is laminated on thin film 12A made of indium tin oxide to form upper electrodes 13.

In other words, a plurality of substantially belt-shaped upper electrodes 13 disposed at the front end portion and the rear end portion of upper substrate 11 in the thin and long manner is formed of the copper foil using the etching process or the like, and thereby upper electrodes 13 can have the line width or the line interval of about 0.03 mm to 0.05 mm. That is to say, the upper electrodes can be formed thinner and thus the interval between the electrodes can be further narrowed.

A plurality of upper electrodes 13 is formed of the copper foil using the etching process or the like, and thereby it is possible to thin upper electrodes 13 or to narrow the interval therebetween. For this reason, it is possible to miniaturize the overall touch panel or to increase an operation region. Since upper electrodes 13 can be formed without the spreading or the scratching, the stable connection to the electronic circuits of electronic device is enabled and therefore an operation can be reliably performed.

Base substrate 10 provided with base conductive layer 8 is attached to the entire lower surface of lower substrate 4. By this configuration, it is possible to remove, using base conductive layer 8, electronic noise generated from the touch panel when a finger or the like touches the upper surface of cover substrate 7 or electronic noise from the display device placed in the rear face of the touch panel. Therefore, it is possible to perform a more stable input operation without introducing errors.

Furthermore, only upper electrodes 13 are formed of the copper foil, and lower electrodes 6 or base electrode 9 are respectively formed using the screen printing or the like, and thereby the touch panel can be manufactured at a relatively low cost.

A plurality of lower electrodes 6 of lower substrate 4 may be also formed of the copper foil like upper electrodes 13 using the etching process or the like although the touch panel is manufactured at a slightly high cost. Thereby, since there is no need for heating for drying lower substrate 4, which is accompanied by the screen printing or the like, it is possible to prevent a misalignment with upper substrate 11 due to the contraction of lower substrate 4.

As described above, according to this embodiment, a plurality of substantially stripe-shaped upper electrodes 13 extending from upper conductive layers 12 in the perpendicular direction or lower electrodes 6 extending from lower conductive layers 5 are formed of the copper foil, and thereby it is possible to form upper electrodes 13 or lower electrodes 6 which realize a thinned line or narrowed line interval without the spreading or the scratching by using the etching process or the like. Therefore, the overall miniaturization or increase in an operation region cannot only be implemented, but stable connection to the electronic circuits of the device can be also performed, thereby obtaining the touch panel which can be reliably operated.

### Second Embodiment

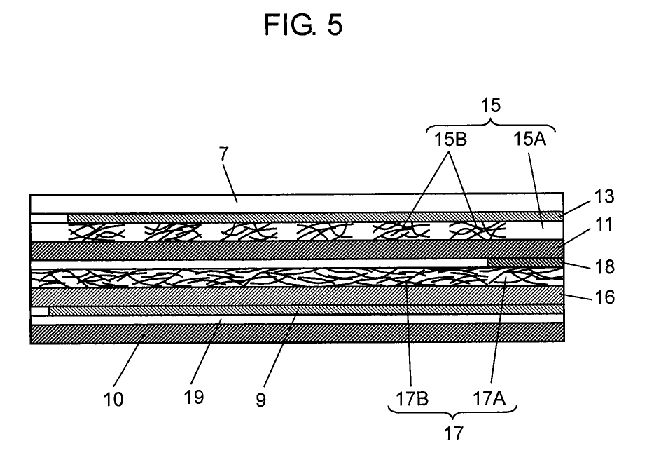

Hereinafter, a touch panel according to a second embodiment of the present invention will be described with reference to FIGS. 5 to 7E. In addition, the constituent elements the same as those in the first embodiment are given the same reference numerals and the detailed description thereof will be omitted.

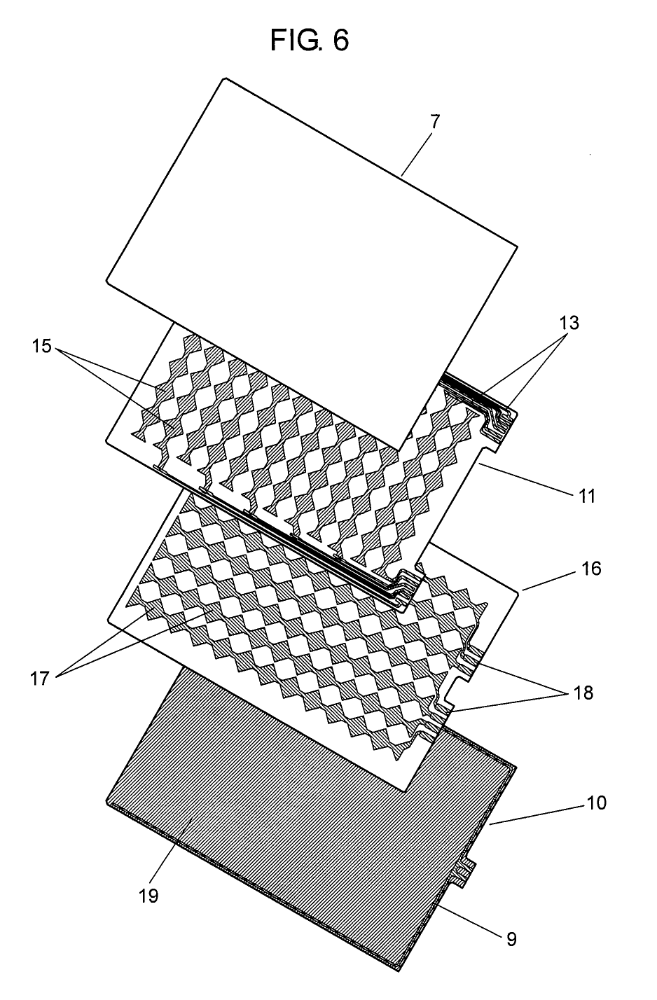

FIG. 5 is a sectional view of a touch panel according to the second embodiment of the present invention. FIG. 6 is an exploded perspective view of the touch panel according to the second embodiment of the present invention.

In FIGS. 5 and 6, the second embodiment is the same as the first embodiment in that upper conductive layers 15 are arranged and formed on the upper surface of upper substrate 11 in the longitudinal direction. However, unlike the first embodiment, a plurality of conductive metal thin lines 15B such as silver or the like having a diameter of about 10 to 100 nm and a length of about 1 to 15 μm is dispersed in ultraviolet curable resin 15A in predetermined parts such as acryl or the like having the thickness of about 0.1 to 20 μm, thereby forming upper conductive layers 15.

Upper electrodes 13 have one ends connected to end portions of upper conductive layers 15 and the other ends extending to the right end of the outer circumference of upper substrate 11. Upper electrodes 13 are formed of a copper foil having the thickness of about 20 nm to 10 μm. A plurality of upper electrodes 13 is formed extending in the transverse direction perpendicular to upper conductive layers 15. Upper electrodes 13 are formed at end portions in the side to which upper conductive layers 15 extend in upper substrate 11.

Lower substrate 16 has a film shape and a light transmissive characteristic like upper substrate 11. Lower conductive layers 17 are formed by dispersing a plurality of conductive metal thin lines 17B in ultraviolet curable resin 17A like upper conductive layers 15. A plurality of substantially belt-shaped lower conductive layers 17 is arranged and formed on the upper surface of lower substrate in the transverse direction perpendicular to upper conductive layers 15. Lower conductive layers 17 have a light transmissive characteristic.

Lower electrodes 18, like upper electrodes 13, are formed of a copper foil. Lower electrodes 18 have one ends connected to end portions of lower conductive layers 17 and the other ends extending to the right end of the outer circumference, and a plurality of lower electrodes 18 is formed extending in the parallel direction (transverse direction) to lower conductive layers 17. Lower electrodes 18 are formed in the side to which lower conductive layers 17 extend in lower substrate 16.

A plurality of upper conductive layers 15 and lower conductive layers 17 have a plurality of substantially rectangular portions connected in a belt shape like the first embodiment. A plurality of substantially rectangular gap portions is provided between upper conductive layers 12 or lower conductive layers 5. In the state where upper substrate 11 and lower substrate 16 overlap each other, the rectangular portions of upper conductive layers 15 overlap the gap portions of lower electrodes 18, and the rectangular portions of lower conductive layers 17 overlap the gap portions of upper electrodes 13.

Base substrate 10 is provided with base conductive layer 19 having a light transmissive characteristic the same as upper conductive layers 15 or lower conductive layers 17, on its entire upper surface. Base electrode 9 is formed in a substantially U shape so as to extend from the front end portion and the rear end portion of base conductive layer 19 to the right end of the outer circumference of base substrate 10.

Lower substrate 16, upper substrate 11, and cover substrate 7 sequentially overlap the upper surface of base substrate 10, and the touch panel is configured by attaching them to each other, which is the same as the first embodiment.

In other words, in this embodiment, a plurality of upper conductive layers 15 arranged and formed in the longitudinal direction and lower conductive layers 17 arranged and formed in the transverse direction perpendicular thereto are formed of ultraviolet curable resin 15A or 17A in which conductive metal thin lines 15B or 17B are dispersed. Upper conductive layers 15 and lower conductive layers 17 are disposed opposite to each other with a predetermined gap by interposing upper substrate 11 therebetween. Upper electrodes 13 extending from upper conductive layers 15 and lower electrodes 18 extending from lower conductive layers 17 are formed of the copper foil.

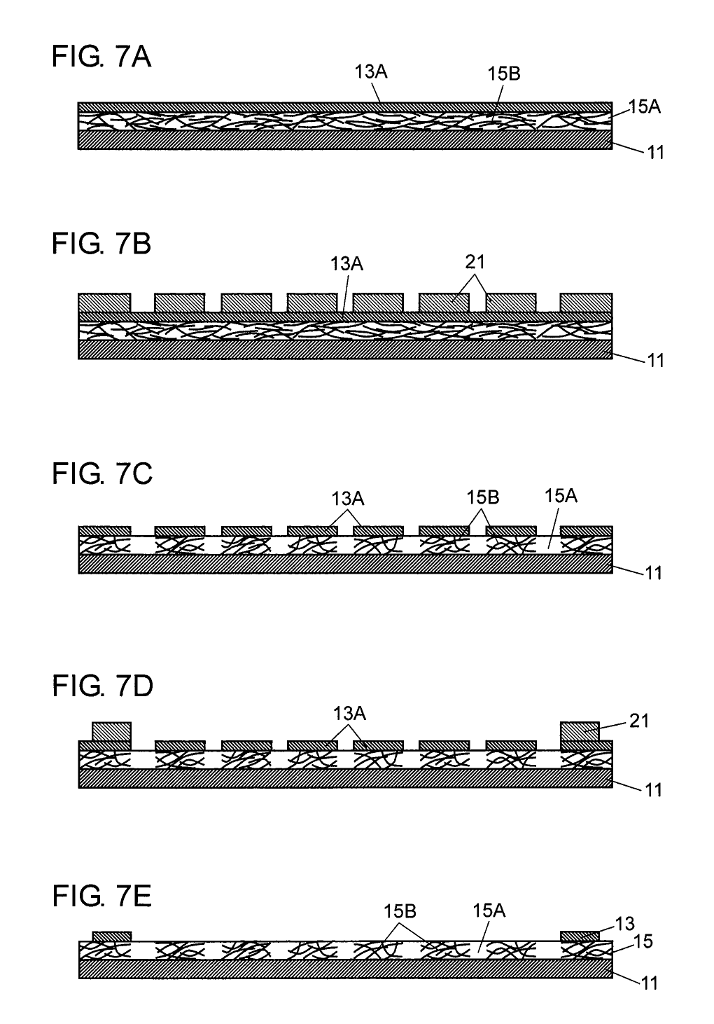

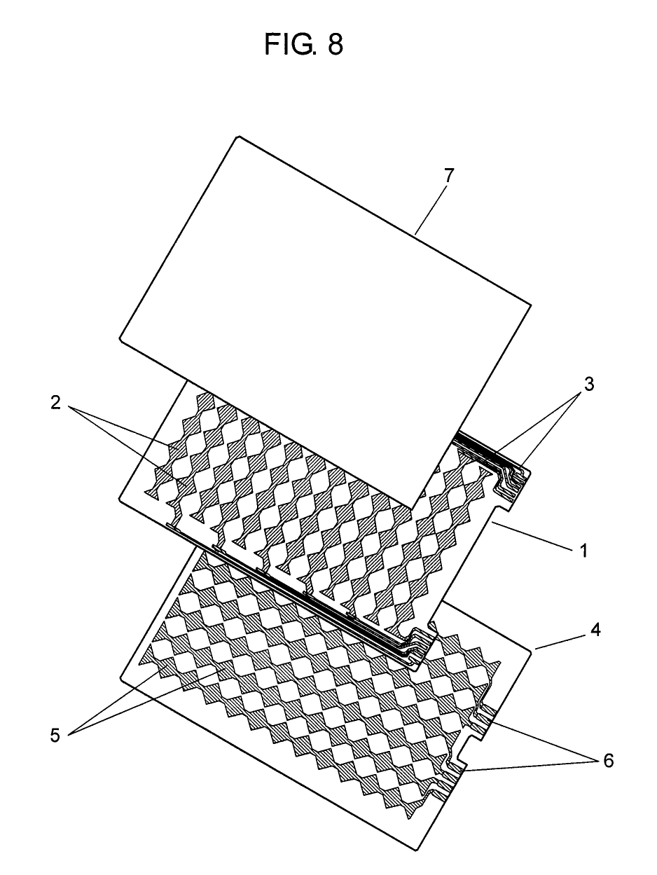

A method of manufacturing, for example, upper substrate 11 of the touch panel will be described with reference to FIGS. 7A to 7E. FIGS. 7A to 7E are partially sectional views of the touch panel according to the second embodiment of the present invention.

As shown in FIG. 7A, first, ultraviolet curable resin 15A and copper foil 13A are sequentially laminated on the upper surface of upper substrate 11. A plurality of conductive metal thin lines 15B is entirely dispersed in ultraviolet curable resin 15A.

As shown in FIG. 7B, upper substrate 11 is exposed and developed by the photoresist method or the like so as to mask the upper surface of copper foil 13A with coats 21 made of insulating resin such as a dry film or the like. Thereby, parts forming patterns of upper conductive layers 15 are covered by coats 21.

Next, upper substrate 11 is immersed in an etchant such as ammonium persulfate diluted aqueous solution or the like. Thereby, only copper foil 13A in unnecessary parts which are not covered by coats 21 is melted and removed. Thereafter, upper substrate 11 is immersed in an etchant such as a dilute aqueous solution where phosphoric acid and nitric acid are mixed with each other, and thereby conductive metal thin lines 15B and ultraviolet curable resin 15A placed under the parts where copper foil 13A is removed are melted and removed. Thereby, as shown in FIG. 7C, a plurality of conductive metal thin lines 15B is arranged in a predetermined direction in ultraviolet cured resin 15A to form upper substrate 11 provided with copper foil 13A on ultraviolet curable resin 15A.

Thereafter, as shown in FIG. 7D, the upper surface of a predetermined copper foil 13A is exposed and developed by the photoresist method or the like to be masked with coats 21 again.

Next, upper substrate 11 is immersed in an etchant such as ammonium persulfate diluted aqueous solution or the like to melt and remove copper foil 13A in unnecessary parts which are not covered by coats 21. Thereby, as shown in FIG. 7E, there is completion of upper substrate 11 provided with a plurality of upper conductive layers 15 arranged in a predetermined direction by conductive metal thin lines 15B in ultraviolet curable resin 15A, and a plurality of upper electrodes 13 extending therefrom.

Lower substrate 16 may be manufactured by fundamentally the same method as upper substrate 11.

The touch panel configured in this way is disposed on a front face of a display device such as a liquid crystal display device or the like and mounted on an electronic device. A plurality of upper electrodes 13, lower electrodes 18, and base electrode 9 of the touch panel are electrically connected to electronic circuits (not shown) of the electronic device via a flexible wire board or a connector (not shown).

In the above-described configuration, in the state where the electronic circuits sequentially supply voltages to a plurality of upper electrodes 13 and lower electrodes 18, a finger or the like touches the upper surface of cover substrate 7 for operation, according to the display on the display device placed in the rear face of the touch panel. Thereby, a capacitance between upper conductive layers 15 and lower conductive layers 17 in the operated place varies. The operated place is detected by the electronic circuits based on the variation of the capacitance, and various functions of the electronic device are switched.

In other words, for example, if a finger or the like touches the upper surface of cover substrate 7 over a desired menu in a state where a plurality of menus or the like is displayed on the display device placed in the rear face of the touch panel, a portion of electrical charge is conducted to the finger. Thereby, a capacitance between upper conductive layers 15 and lower conductive layers 17 of the touch panel in the operated place varies. The electronic circuits detect the variation of the capacitance and thereby selection of a desired menu or the like is performed.

Upper conductive layers 15 or lower conductive layers 17, and base conductive layer 19 of the touch panel are formed of ultraviolet curable resin 15A or 17A in which a plurality of conductive metal thin lines 15B or 17B is dispersed, and thereby it is possible to configure the touch panel at a low cost as compared with a case where they are formed of a metal thin film made of a high-priced indium tin oxide or the like.

By forming upper conductive layers 15 or lower conductive layers 17 as in this embodiment, light transmittance is 91 to 92% higher than a case where upper conductive layers 15 or lower conductive layers 17 are formed of the metal thin film made of indium tin oxide or the like. For this reason, the display on the liquid crystal display device or the like placed in the rear face of the touch panel can be easily viewed and thus visibility becomes better, thereby easily performing an operation.

In other words, upper conductive layers 15 or lower conductive layers 17, and base conductive layer 19 are formed of ultraviolet curable resin 15A or 17A in which relatively low-priced conductive metal thin lines 15B or 17B are dispersed, and thereby upper conductive layers 15 or lower conductive layers 17 can be formed comparatively simply using the etching process or the like. Therefore, it is possible to obtain the touch panel which can be reliably operated at a low cost.

A plurality of upper electrodes 13 or lower electrodes 18 are formed of the copper foil using the etching or the like, and thereby it is possible to form upper electrodes 13 or lower electrodes 18 having the electrode width or the interval between electrodes of about 0.03 to 0.05 mm. That is to say, it is possible to thin upper electrodes 13 or lower electrodes 18 or to narrow the interval therebetween.

In other words, it is possible to thin upper electrodes 13 or lower electrodes 18 or to narrow the interval therebetween by forming a plurality of upper electrodes 13 or lower electrodes 18 using the copper foil. Therefore, it is possible to miniaturize the overall touch panel or to increase an operation region. Also, since upper electrodes 13 or lower electrodes 18 can be formed without the spreading or the scratching, the stable connection to the electronic circuits of electronic device is enabled and therefore an operation can be reliably performed.

The above description has been made of the configuration where upper conductive layers 15, lower conductive layers 17, and base conductive layer 19 are all formed of ultraviolet curable resin 15A or 17A in which conductive metal thin lines 15B or 17B are dispersed. However, base conductive layer 19, which is formed on the entire upper surface of base substrate 10 and for which removal by the etching process or the like is hardly necessary, may be made of indium tin oxide, tin oxide, or the like by the sputtering method or the like. Even when only either upper conductive layers 15 or lower conductive layers 17 are formed of the ultraviolet curable resin in which the conductive metal thin lines are dispersed, the present invention can be implemented.

The above description has been made of the configuration where both of upper electrodes 13 and lower electrodes 18 are formed of the copper foil. However, lower electrodes 18, which are formed extending in the transverse direction parallel to lower conductive layers 17 and have some margin in the line width or the line interval as compared with upper electrodes 13, may be made of silver, carbon, or the like by screen printing. In other words, even when only upper electrodes 13 extending in the perpendicular direction to upper conductive layers 15 are formed of the copper foil, the touch panel in this embodiment can be manufactured at a low cost.

In this way, according to this embodiment, at least one of upper conductive layers 15 or lower conductive layers 17 is formed of ultraviolet cured resin 15A or 17A in which conductive metal thin lines 15B or 17B are dispersed, and thereby it is possible to relatively simply form upper conductive layers 15 or lower conductive layers 17 using the etching process or the like. In addition, it is possible to obtain the touch panel which can be reliably operated at a low cost.

At least one of a plurality of upper electrodes 13 extending from upper conductive layers 15 and a plurality of lower electrodes 18 extending from lower conductive layers 17 is formed of the copper foil to thin the electrodes or narrow the interval therebetween, thereby miniaturizing the overall touch panel or increasing an operation region. Further, it is possible to prevent the electrodes from being spread or scratched, thereby realizing stable connection to the electronic circuits of the electronic device.

The above description has been made of the configuration where lower substrate 4 or lower substrate 16 is attached to the lower surface of upper substrate 11. However, upper substrate 11 and lower substrate 4 or lower substrate 16 may be placed upside down, and upper substrate 11 may be attached to the lower surface of lower substrate 4 or lower substrate 16. Even when upper conductive layers 12 or upper conductive layers 15, and lower conductive layers 5 or lower conductive layers 17 are respectively formed on the upper and lower surfaces of upper substrate 11 instead of lower substrate 4 or lower substrate 16, the present invention can be implemented.

According to the embodiments of the present invention, there are advantages in that it is possible to obtain the touch panel which can be reliably operated at a low cost, and the touch panel is suitable for operation of various kinds of electronic devices.

What is claimed is:

1. A touch panel comprising:
an upper substrate;
a lower substrate opposite to the upper substrate with a predetermined gap therebetween;
a plurality of belt-shaped upper conductive layers formed on the upper substrate and arranged in a predetermined direction;
a plurality of upper electrodes having one ends connected to end portions of the upper conductive layers and the other ends extending to an outer circumference of the upper substrate;
a plurality of stripe-shaped lower conductive layers formed on the lower substrate and arranged in a direction perpendicular to the upper conductive layers with a predetermined gap between the lower conductive layers and the upper conductive layers; and
a plurality of lower electrodes having one ends connected to end portions of the lower conductive layers and the other ends extending to an outer circumference of the lower substrate,
wherein at least one of the upper electrodes and the lower electrodes is formed of a copper foil.

2. The touch panel of claim 1, wherein at least one of the upper conductive layers and the lower conductive layers is formed of ultraviolet curable resin in which conductive metal thin lines are dispersed.

3. The touch panel of claim 1, wherein the upper electrodes are formed in a direction perpendicular to the upper conductive layers, and
wherein the lower electrodes are formed in a direction parallel to the lower conductive layers.

4. The touch panel of claim 1, wherein the upper electrodes are formed at end portions in a side to which the upper conductive layers extend on the upper substrate, and
wherein the lower electrodes are formed at end portions in a side to which the lower conductive layers extend on the lower substrate.

5. The touch panel of claim 1, wherein the upper conductive layers and the lower conductive layers are formed by connecting a plurality of rectangular portions to each other in a belt shape.
